(19) United States
(12) Patent Application Publication
(10) Pub. No.: US 2006/0237410 A1
(43) Pub. Date: Oct. 26, 2006

(54) Positive current cutoff safety switch for welding torch

(76) Inventor: Joseph J. Ward, Collegeville, PA (US)

Correspondence Address: Robert B. Famiglio, Esquire;FAMIGLIO & ASSOCIATES, P.O. BOX 1999, Media, PA, 19063, US

(21) Appl. No.: 11/111,215

(22) Filed: Apr. 21, 2005

(51) Int. Cl. B23K 9/10

(52) U.S. Cl. 219/136

(57) ABSTRACT

A manual welding safety disconnect to provide the welder the ability to stop current flow to a TIG (GTAW) torch or a stick (SMAW) welding lead where it attaches to the supply cable which would allow the operator to prevent further current flow by causing a misalignment of the enclosed electrical contacts. Misalignment of the electrical contacts by a rotation around the inert gas tube permits the operator to immediately shut off the welding current while still allowing the gas flow in the TIG version. This configuration also is more convenient for the welder since he would not have to leave his work area. This safety device would reduce the risk of electric shock, accidental arc strike, and arc flash. This device can isolate any one lead or torch to produce a safe zero energy mode even if operating from a multibank power supply.

### BACKGROUND OF THE INVENTION

1. Field of the Invention

This invention relates to a welding safety disconnect to be used in stick welding (SMAW) or TIG welding (GTAW) to disable current flow at the point of operation while maintaining all connections including the inert gas connection for a TIG torch.

2. Description of the Prior Art

The use of welding has been popular for quite some time and is used frequently in construction, all forms of metal fabrication, ship building and in other uses. The welding process is reliant on the supply of current to the lead or torch that causes metal to heat up and melt, thus creating a weld and joining the work piece materials.

Shielded Metal Arc Welding (SMAW) is frequently referred to as stick or covered electrode welding. Stick welding is among the most widely used welding process. The flux covering the electrode melts during welding. This forms the gas and slag to shield the arc and molten weld pool. The slag must be chipped off the weld bead after welding.

Gas Tungsten Arc Welding (GTAW) is frequently referred to as TIG welding. TIG welding is a commonly used high quality welding process. TIG welding has become a popular choice of welding process when high quality, precision welding is required.

In TIG welding an arc is formed between a nonconsumable tungsten electrode and the metal being welded. Gas is fed through the torch to shield the electrode and the molten weld pool.

In welding the heat to melt metal is a result of an electrical arc produced by a very high current source at a voltage normally less than 50 volts, such as to be within normally accepted ranges of operating voltages such as to present a nonlethal threat to the user. While welding torches or leads can be disconnected from the cabling, it is desirable to have a positive current disconnect which allows a continued attachment of the welding lead or torch to the supply lines while rendering a complete off and safe condition of the current being supplied.

Welding leads or torches are traditionally fully detachable from said supply cable. However, to completely restrict the electric current from reaching the weld point requires the torch or lead to be completely removed or the power supply to be turned off. The removal of the lead or torch is a cumbersome and often time consuming process.

To shut down the power supply to the welding torch is also not a convenient option because the welding is often being performed hundreds of feet from the power supply. Also, many facilities or job sites use multi bank machines or power supplies which would require stopping 6 or 8 welding processes when the machine is turned off to accommodate only one user.

### SUMMARY OF THE INVENTION

The present invention was developed to provide a safer and more effective method for welders to quickly and deliberately disconnect the current from the lead or torch when not in use, or place the torch or lead in a safe mode so the tungsten tip or rod can safely be changed with no risk to the operator. Under standard and currently employed methods, an improperly placed lead or torch can result in shocking third parties who come into contact with the unattended torch or lead. Also, an accidental arc strike could be caused which could result in electrical shock or the flash could cause Welder's Eye. Certain types of ultraviolet radiation caused by welding can produce an injury to the surface or mucous membrane of the eye called “Welder's Eye” or “Arc Flash.” These are common names for “Conjunctivitis” which is an inflamation of the mucous membrane of the front of the eye.

Further, it is frequently desired in TIG welding operations to completely stop the current from flowing into the operator-controlled torch while still allowing the user to direct the inert gas onto the weld and work piece. The present invention comprises a device that can be co-located to a stick (SMAW) welding lead or a second version that can be co-located to a TIG (GTAW) welding torch, through the current supply. A push-pull, or rotatable disconnect mechanism provides a positive current cutoff system to disable the current to the torch or lead without disconnecting the supply line. The invention facilitates placing the torch or lead in a safe mode easily, without any disassembly and without undue delay or inconvenience.

A push-pull or rotatable pair of interlocking cylinder-like halves are aligned coaxial about the power supply line to form a snug, latching or lockable fit for stick welding or gas tight fit for TIG welding which would allow the gas to continue to communicate with the torch while providing terminals to disconnect the high current, low voltage source of power to the torch or lead when the cylinder halves are rotated or pushed/pulled.

The safety disconnect of the present invention utilizes a push-pull or a rotational disconnect action in which a separation is created between the electrical connection in the TIG torch or stick torch lead and the power source cable. Normally the cable connecting a welding machine to the torch is comprised of a single conductor or a single conductor in the outer radius of the connecting cable surrounding a gas tube for inert gas in TIG welding. The disconnect of the present invention is best considered as comprising three main components for TIG welding, including a continuous inner feed tube through which the inert gas can flow and a top and bottom outer interlocking cavity through which welding current can flow when internal conductors are aligned. The center gas tube is unnecessary for stick (SMAW) welding.

The outer housing and inner housing of the interlocking disconnect switch are similarly constructed. Integrated within both sections are the electrical conducting electrodes and the electrically insulating materials which can be axially rotated to align the conducting electrode sections of the two halves to engage the electrodes to complete the conductor leading to the welding torch. The rotation of the switch provides a strong compression connection between both sets of electrodes which cause contact so current may flow from the source or welding machine line to the torch or lead when the safety disconnect is in the closed or “on” position.

The general composition of the handle components and the disconnect which is located in or near the torch handle or lead will be constructed out of an electrically insulated material so that electrical current will only be able to pass through the aligned connector and when the corresponding contacts are aligned.

The electrical conductors and insulators are brought into alignment by rotating or pushing the outer portions of the disconnect between the open and closed positions. When in the close (i.e. operational) position the contacts in the top and bottom of the safety disconnect will be directly aligned. Upon rotation or a pulling action, the conductors will lose contact with one another and align with an insulator to prevent current flow and place the torch or lead in a “safe” mode.

The center feed tube for the inert gas (for TIG i.e. GTAW) will remain unaffected by these actions since the outer cavity continuing the electrical conductors and insulators shall be able to freely traverse around the concentrically located inner feed between its open and closed positions.

An alternative embodiment of the present invention provides for an integration of the switch disclosed into the handle of a typical welding torch. Locating the housing of the switch components at or near the end of a torch handle which otherwise connects to the welding current cable and gas tube insert allow the invention to operate in the fashion disclosed to provide the convenience of the switch or rotational mechanism being integrated into the handle of the torch.

Accordingly, it is the object of the present invention to provide a positive current disconnect mechanism which does not require the operator to disconnect the torch from the welding current line to operate.

It is further an object of the present invention to provide a positive current disconnect mechanism that will allow a MIG or stick welding torch system to remain connected to a welding machine which is still energized while providing easy current disconnect means available to welding torch operator at the welding location.

It is yet another object of the present invention to provide a quick current disconnect mechanism for a conventional TIG or stick welding torch which provides visual indication of whether the current is selected in the “on” or “off” position.

It is a further object of the present invention to provide a current disconnect mechanism which allows a continuous inert gas to feed through the mechanism which disconnecting the current conductors to a conventional TIG torch.

### BRIEF DESCRIPTION OF THE DRAWINGS

FIG. 1A is a pictorial view of the entire invention displaying the safety disconnect mechanism placed in line with a welding torch wire.

FIG. 1B is a cutaway view of the safety disconnect mechanism illustrating the internal electrode connections.

FIG. 1C is a sectional view of the safety disconnect mechanism shown in FIG. 1B.

FIG. 2A is a pictorial view of the entire safety disconnect mechanism illustrating the rotation of the outer housing and selection of an “on” or “off” position.

FIG. 2B is a sectional view of safety disconnect mechanism illustrating the position of the internal electrodes when the switch is in the “off” position.

FIG. 2C is a sectional view of the switch as shown in FIG. 2B with the electrodes arranged in the “off” position.

FIG. 3A is a sectional view of the safety disconnect mechanism illustrating the position of the internal electrodes with the switch in the “on” position, and further illustrating the inert gas tube concentrically positioned through the axis of the switch mechanism.

FIG. 3B is a sectional view of the switch as shown in FIG. 3A, further illustrating position of the inert gas tube coaxially positioned through the rotating cylinders which comprise the switch.

FIG. 4 is a pictorial diagram of the safety disconnect mechanism shown integrated into the handle of a typical welding device.

### DETAILED DESCRIPTION OF THE PREFERRED EMBODIMENT

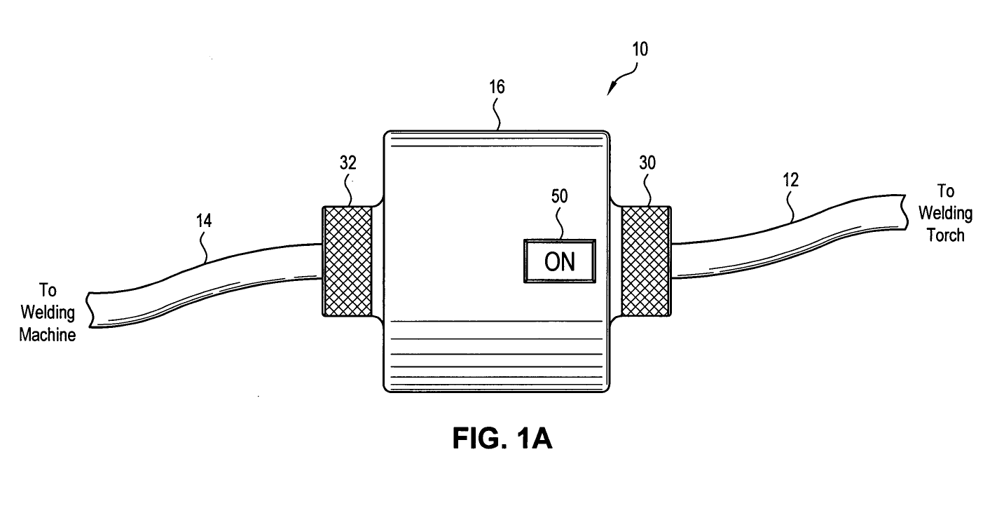

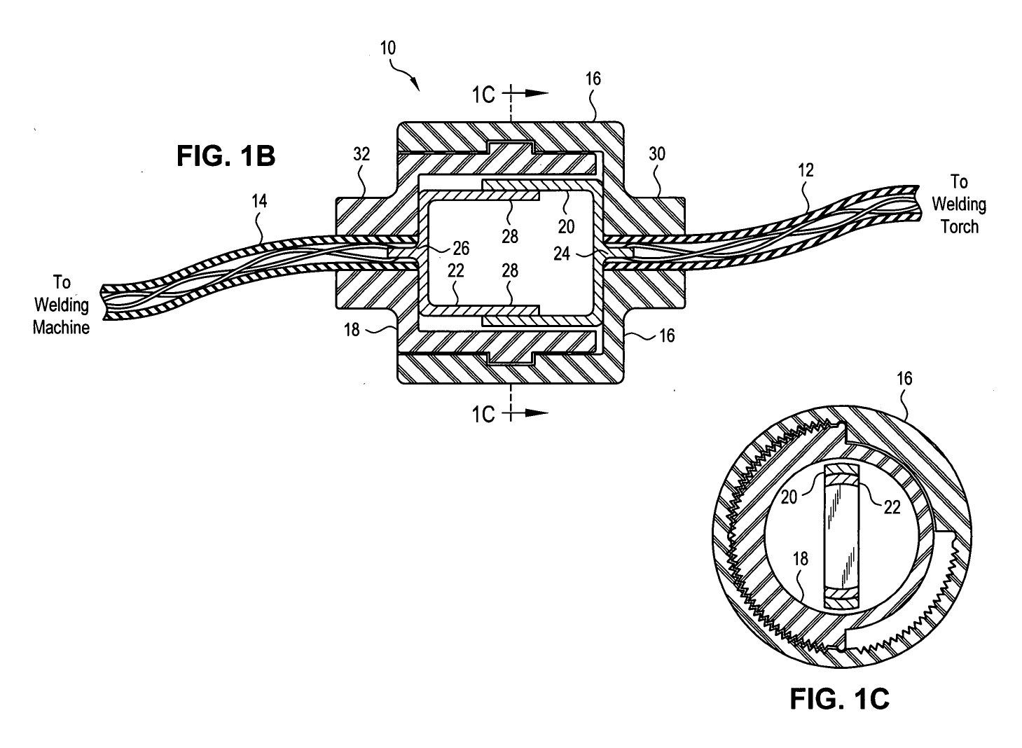

The invention will now be described with reference to the various figures, wherein like-numerals refer to like-parts. Turning to FIG. 1, the entire switch 10 is shown in the “on” position. Switch outer housing 16 is mated slidably to the inner housing 18 shown in a sectional view in FIG. 1B. Switch 10 can be placed anywhere in the welding torch current line of a typical welding machine and torch operation. However, it should be appreciated that switch 10 can be of most effect when it is placed in the general vicinity of the welding torch where an operator will have easy access to the switch mechanism. Switch 10 is comprised of the machine line 14 bringing current from a typical welding machine. Torch line 12 is the conductor presenting current from switch 10 to a welding torch in the vicinity of the switch. Outer rotational knob 30 is used to rotate the mechanism internally where lower rotational knob 32 can be held in a stationary position to allow the inner housing 18 and outer housing 16 to rotate in relation to each part.

FIG. 1B shows switch 10 in the closed position, wherein current flows through the switch because of the continuity presented by the connection of outer electrode 20 and inner electrode 22. It can be seen in FIG. 1B, conductor 14 attaches to inner electrode 22 at connection 26, while the welding torch line 12 is connected to the outer electrode 20 at wire connection 24. Outer electrode 20 and inner electrode 22, when placed in the “on” position contact each other at location 28, illustrated in FIG. 1 B. Electrodes 20 and 22 are fashioned such as to have sufficient contact area when in the closed or “on” position as to prevent appreciable resistance between the electrodes when they are contacting each other as shown in FIG. 1B. When switch 10 is in this position, current flows because of the continuity presented by electrodes 22 and 20 by completing the circuit of the current through the switch, to the welding torch and the electrode or tip of the torch which completes the current through the ground connection normally attached to the work piece being welded in a typical operation.

FIG. 1C is a sectional view through FIG. 1B as shown providing an end view of the outer electrode 20 and inner electrode 22 when they are rotated into the “on” position, thereby allowing current to flow from the welding machine to the welding torch. It should also be appreciated that the means of contact between electrode 20 and electrode 22 can be accomplished through a variety of different means. In the example displayed in FIG. 1B and FIG. 1C, the electrodes rotate in a coaxial fashion intersecting each other to contact across the broad end of each electrode as shown specifically in FIG. 1C. In a similar fashion, electrodes 20 and 22 can intersect each other by direct contact end on end and accomplish the same purposes of the invention. The object in the rotational switch is to be sure that there is ample conductivity between the electrodes to provide continuity when the switch is selected on and not introduced appreciable resistence between the two electrodes to prevent a drop in current across the switch. The switch electrodes would be constructed of a high conductivity material, whether copper or even silver plated contacts to prevent oxidation or resistance from forming in the switch elements. Since switch housing 16 can be constructed in a fashion to allow it to be dismantled from time to time, electrodes 20 and 22 can be subject to inspection or cleaning occasionally in the normal maintenance process.

As can be seen in FIG. 1C, the outer housing 16 and inner housing 18, both of which comprised with switch 10 have a drag resistance or ratcheting mechanism which allows the two halves to be rotated into the closed position with the outer and inner housing reaching a stopped position when electrode 20 and electrode 22 are aligned to conduct current. It can be appreciated by one skilled in the art that there are various mechanisms which could be used to allow the inner and outer housings suggested in FIG. 1B and FIG. 1C to mate coaxially such as to provide for a positive stop position when the internal electrodes are aligned as required in either the current “on” or current “off” position. Such a detent or ratcheting mechanism can provide sufficient resistance such as to cause the outer housing 16 and inner housing 18 to require enough force as to prevent inadvertent rotation of the halves other than when the operator desires to have the halves rotate under application of sufficient torque. It is also possible to provide entirely different housing mechanisms which provides the same internal connections or disconnections but applies lateral force through a snap-on or snap-off mechanism in an alternate embodiment.

In the present invention it is useful to have a positive flag condition illustrating whether the switch is in the “on” or “off” position due to rotation. As shown in FIG. 1A, when the electrodes are aligned to provide for continuity through switch 10, status window 50 displays an “on” condition flag. Window 50 is aligned to the surface of switch inner housing 18 so that when the switch is aligned to conduct current, the “on” printing or other colored or warning flag condition can be seen through status window 50 which shows through outer housing 16.

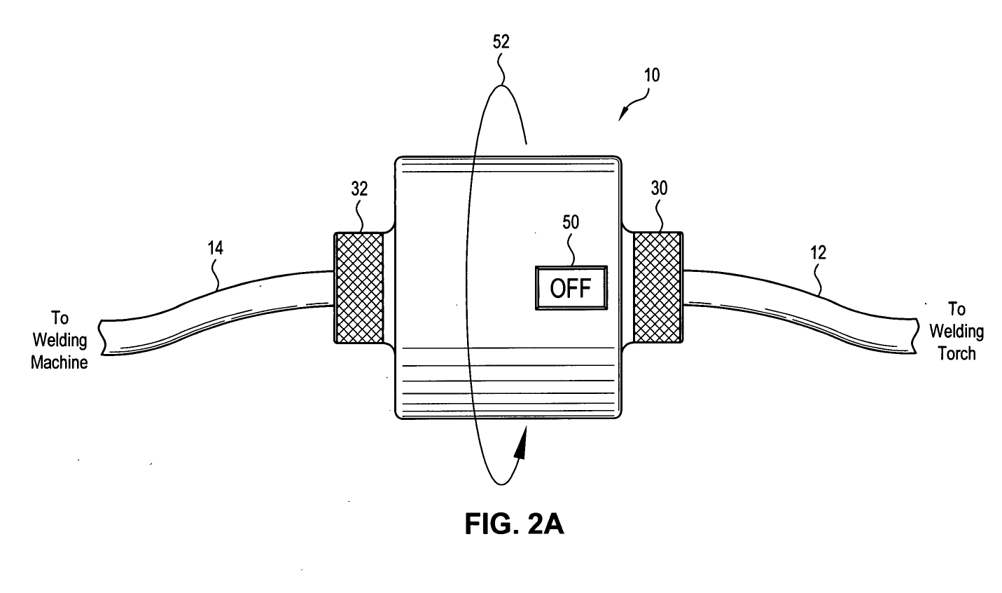

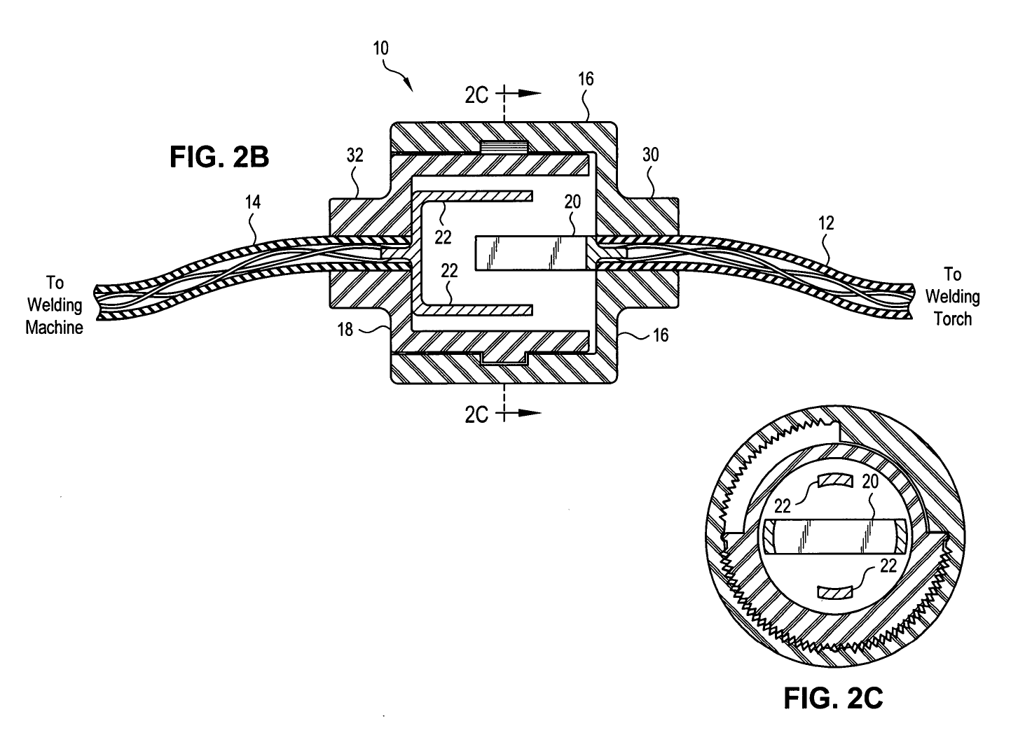

Turning now to FIG. 2A, switch 10 is shown in the “off” position. It can be appreciated, rotating the switch can be accomplished by rotating the two halves of the switch to accomplish through upper rotation knob 30 and lower rotation knob 32, each separately connected to the outer housing 16 and the inner housing 18 respectively. Rotating one housing of switch 10 in one direction while holding the other stationary, the internal electrodes can be disaligned as shown by housing rotation 52 in FIG. 2A.

FIG. 2B is a sectional view of the switch selected in the “off” position, wherein it can be appreciated how electrodes 20 and 22 are disaligned with each other to break the continuity of the welding torch current line. A sectional view of switch 10 in the “off” position is shown in FIG. 2C where the electrodes are separated such that current flow is stopped and the welding torch is rendered current safe. Once again, it can be appreciated from FIG. 2C how a ratcheting mechanism and positive detents or stops can be molded into the housing to provide a positive feel for the stop position when the switch is rotated 90 degrees from the “on” position.

FIG. 1 and FIG. 2 all illustrate switch 10 in its simplest configuration for use with a welding torch engaged in stick welding operation. In TIG welding, a single current conductor is used to apply high current, low voltage power to the welding torch but an inert gas is also conducted up the same cable to provide such welding gases to the gas cup built into a typical TIG welding torch. In such a case, it can be appreciated that while positive current shutoff is desired for the same safety reasons, switch 10 must provide for an internal, coaxial gas tube to allow the welding gas to travel uninterrupted through the switch whether or not the switch is in the positive contact or current “off” position. In fact, many times it is desirable to allow the welding gas to continue to flow to the welding torch while the current is shut off momentarily or for a longer period of time.

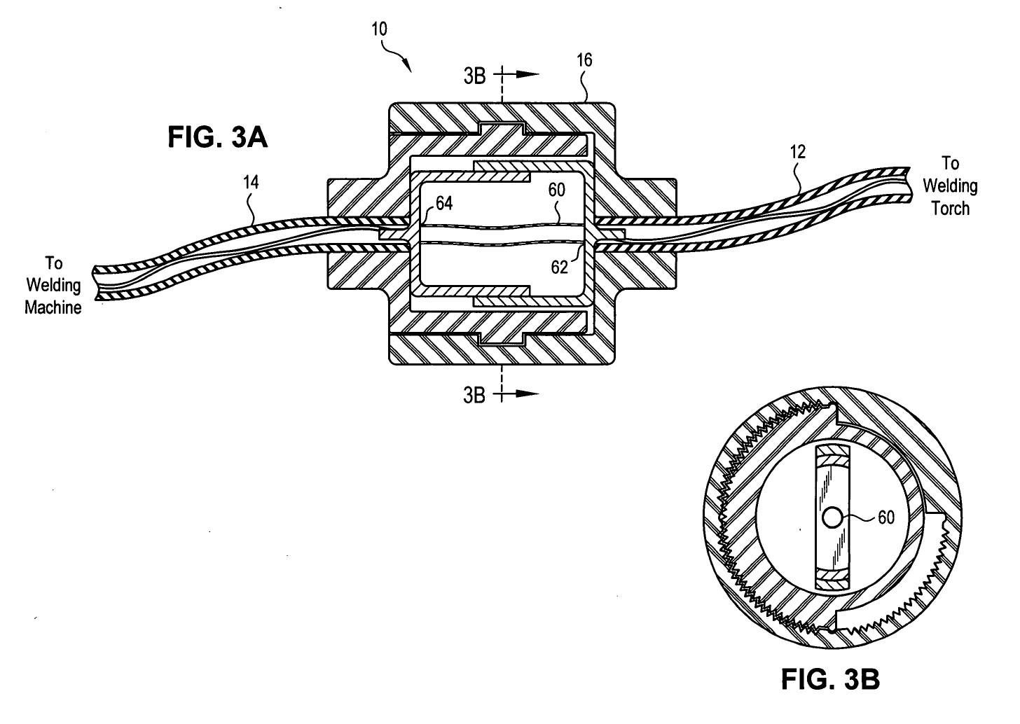

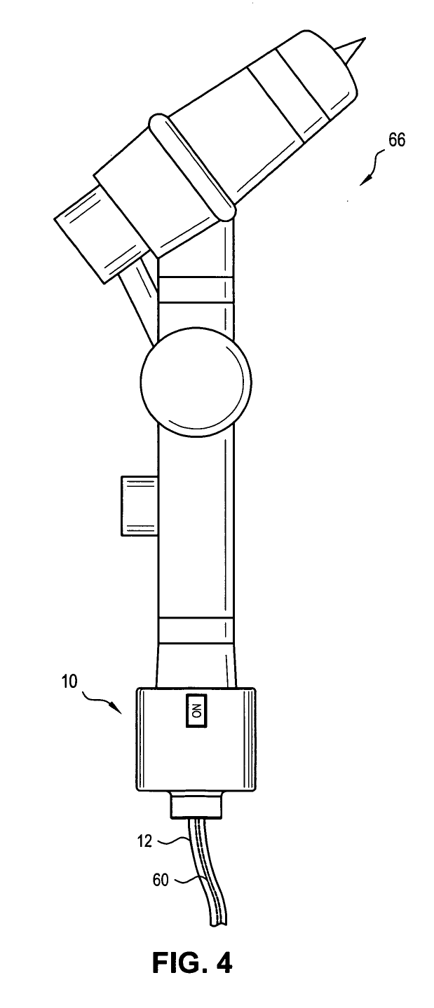

In turning to FIG. 3A and FIG. 3B, a variation of the invention is shown, whereby switch 10 contains a gas tube which travels through switch 10 as illustrated, allowing gas tube 60 to move through the interior area of switch 10 such that the gas tube is undisturbed by the rotating outer housing 58 and inner housing 60. In accordance with this variation, it can be appreciated that gas tube 60 continues to allow flow of an inert gas to the welding torch even though switch 10 can be used in the fashion described above to cut off the current to the torch.

The variation of switch 10 shown in FIG. 3A would be necessary when using the invention in conjunction with TIG welding so that a typical TIG torch as shown in FIG. 4 would have inert gas available to it for use in normal operation. The inert gas tube 60 as shown in FIG. 3A and FIG. 4 could be of a flexible design such as is normally used in welding cables for such applications such that rotation of switch 10 ninety degrees to select an “on” or “off” position would not cause undue deformity of tube 60. It is also possible to complete switch 10 such that gaskets are formed at the interface of tube 60 as shown at 62 and 64 in FIG. 3A. With rubber O-rings or gasket designs, it would be a simpler matter to retrofit an existing TIG welding line such as cut the line, install switch 10 on the line and reconnect the gas line through tube 60, thereby allowing a simpler retroactive installation of the safety switch 10 without need to replace the entire welding line from the welding machine to the welding torch.

In keeping with the improvements described in the present invention, switch 10 can be integrated in a welding torch handle where torch line 12 actual connects to the lower end of a conventional welding torch as illustrated in FIG. 4, so that the switch can be part of the lower portion of a handle. Whether switch 10 is situated several feet from the welding torch or integrated in the handle as suggested in FIG. 4, the operation of the switch would be similar, if not identical to the internal electrode configuration such as to allow the current to be positively locked off while the welding machine is still selected in the “on” position. As can be seen from FIG. 4, the switch housing is integrated into the handle, thereby providing that half of the housing is stationary with the welding torch handle. Either torch 66 can be rotated to select the “off” position, or the housing of switch 10 can be rotated with the cable and gas tube 60 therein in order to select the “off” position. Adding switch 10 to the handle of torch 66 adds some weight to the torch, but in many instances is a preferred design depending on the application and size of the torch.

The advantage of the switch located in an existing cable removed from the torch 66 allows for retrofitting existing torch designs which the handles do not necessarily adopt well to the integration of the switch as suggested in FIG. 4. The invention as disclosed provides for retrofitting existing welding apparatus by cutting the cable at a point convenient for the location of switch 10 and attaching the electrodes to machine line 14 and torch line 12. It is also possible to retrofit TIG welding apparatus by cutting the gas tube traveling within the same cable and affixing the gas tube switch 10 to allow continuity through the switch as shown in FIGS. 3A and 3B. The inert gas supplied in TIG welding is normally not under high pressure and does not present a hazard or a risk by retrofitting the gas tube as suggested to allow for the switch to be retrofitted onto existing cables and welding lines for torch apparatus in the field.

A modification to the system would incorporate a different visible indica of status into the safety disconnect. The top portion and the bottom section of the safety disconnect could have another set of electrical contacts than when in the on position would provide current to a small light device, such a light emitting diode in the handle section of the lock indicating whether the device was in the “on” or “safe” mode. This would allow anyone unsure of the condition of the torch or lead to determine its status immediately and unmistakenly by additional means other than physical observation of the disconnect so as to be sure of the condition of the torch or lead.

A further modification would include a safety locking mechanism that would require the user to depress a button in conjunction with twisting or pushing to restore current to the torch or lead. This button would have been automatically released during the twisting or pulling action to remove the current. This would prevent any accidental restorations of current.

Although the invention has been described in terms of the preferred embodiment and with particular examples that are used to illustrate carrying out the principles of the invention, it would be appreciated by those skilled in the art that other variations or adaptation of the principles disclosed herein could be adopted using the same ideas taught herewith. Such applications and principles are considered to be within the scope and spirit of the invention disclosed and are otherwise described in the appended claims.

What is claimed is:

1. A Switch for selectively applying current to a welding torch comprising:
a first electrode adapted to connect to a wire providing current from a welding machine;
a second electrode adapted to connect to a wire which provides current to a welding torch;
a housing adapted to support said first and second electrode in selectable contact with each other;
wherein further said housing encloses said electrodes and selectively moves to cause contact between said electrodes.

2. The switch of claim 1 wherein said housing is comprised of at least two parts, a first part supporting said first electrode and a second part supporting said second electrode.

3. The switch of claim 2 wherein further said first part of said housing is configured to coaxially mate with said second part of said housing.

4. The switch of claim 2 wherein further said housing parts are configured to lock into positions relative to said first and said second parts to positively engage said first and second electrodes in an on or off position.

5. The switch of claim 3 wherein further said housing parts are configured to lock into positions relative to said first and said second parts to positively engage said first and second electrodes in an on or off position.

6. The switch of claim 2 further including means to indicate whether said electrodes are in contact to conduct current there through.

7. The switch of claim 3 further including means to indicate whether said electrodes are in contact to conduct current there through.

8. The switch of claim 4 further including means to indicate whether said electrodes are in contact to conduct current there through.

9. The switch of claim 1 wherein said housing is integrated into the handle of a welding torch.

10. A current switch control for use in an arc welding assembly of the type having:
a welding power supply to supply power to the torch through a conductor cable for supplying power to an electrode, said welding current switch comprised of a housing;
a first electrode connected to said conductor attached to the said power supply;
a second electrode connected to said conductor attached to the welding torch, and means to rotate the housing such as to provide for said first and second electrode to selectively conduct current through the housing or disconnect such current at the selection of the operator.

11. A switch for an electric welding torch comprising:
a housing mountable on a current conducting wire used to feed current from a welding machine to a welding torch;
switching means in said housing for selectively opening and closing an electrical circuit;
wherein further, said switching means is operatively connected to said housing such that the rotation of the housing selects the switching means to conduct current or to disconnect current alternatively as the housing is rotated.
